(19) United States
(12) Patent Application Publication
(10) Pub. No.: US 2007/0252492 A1
(43) Pub. Date: Nov. 1, 2007

(54) Data storing device

(75) Inventor: Wei-Chung Hsu, Taipei Hsien (TW)

Correspondence Address: OSTROLENK FABER GERB & SOFFEN, 1180 AVENUE OF THE AMERICAS, NEW YORK, NY, 100368403, US

(73) Assignee: Universal Scientific Industrial Co., Ltd.

(21) Appl. No.: 11/411,720

(22) Filed: Apr. 26, 2006

(51) Int. Cl. E05B 65/46

(52) U.S. Cl. 312/219

(57) ABSTRACT

A storing device includes: a housing with a plurality of carriers withdrawable from the housing, each of the carriers having an operating member movable between operable and non-operable positions and locked against movement by a latch; and a limiting unit including a linking lever with a plurality of stoppers. The linking lever is movable to a position, in which each stopper is aligned with the latch of a corresponding carrier so as to block the latch from movement from a locked position to an unlocked position, thereby preventing movement of the operating member from the non-operable position to the operable position.

### BACKGROUND OF THE INVENTION

1. Field of the Invention

The invention relates to a data storing device, more particularly to a data storing device having a key-operated lock and a linking lever with stoppers.

2. Description of the Related Art

FIG. 1 illustrates a conventional data storing device 2 that includes a housing 21, a front cover 22 connected to a front open end of the housing 21, a plurality of carriers 3 mounted in the housing 21 and aligned vertically, and a plurality of hard disks 5 mounted on the carriers 3, respectively. Each of the carriers 3 is provided with a key-operated lock 4 for locking the carrier 3 in the housing 21. Each of the carriers 3 can be withdrawn out of the housing 21 using a corresponding key (not shown).

The conventional data storing device 2 is disadvantageous in that it requires one key for withdrawing each carrier 3 out of the housing 21, which results in an increase in manufacturing costs. Moreover, it is relatively inconvenient to find a correct key to unlock the corresponding lock 4 during withdrawing of a selected carrier 3 from the housing 21.

### SUMMARY OF THE INVENTION

Therefore, the object of the present invention is to provide a data storing device that can overcome the aforesaid drawbacks associated with the prior art.

Accordingly, a data storing device of this invention comprises: a housing defining an accommodating space therein and a front opening; a plurality of carriers mounted in the accommodating space in the housing and aligned in a vertical direction, each of the carriers being withdrawable out of the accommodating space through the front opening in the housing in a horizontal direction, and being provided with an operating member for withdrawing the respective one of the carriers out of the accommodating space, the operating member of each of the carriers being movable relative to the carrier between a non-operable position, in which manual operation of the operating member to withdraw the respective one of the carriers is not permitted, and an operable position, in which manual operation of the operating member to withdraw the respective one of the carriers is permitted; a plurality of latches, each of which is mounted movably on a respective one of the carriers and each of which is movable relative to the respective one of the carriers between a locked position, in which the latch engages the operating member of a respective one of the carriers, thereby preventing movement of the operating member of the respective one of the carriers from the non-operable position to the operable position, and an unlocked position, in which the latch is disengaged from the operating member of the respective one of the carriers, thereby permitting movement of the operating member of the respective one of the carriers from the non-operable position to the operable position; and a limiting unit mounted on the housing and including a key-operated lock, a linking lever coupled to the key-operated lock and operable by the key-operated lock to move relative to the housing in the vertical direction between limiting and releasing positions, and a plurality of stoppers provided on the linking lever so as to be co-movable with the linking lever in the vertical direction. The stoppers are respectively associated with the latches in such a manner that each of the latches is blocked by the respective one of the stoppers from movement from the locked position to the unlocked position when the linking lever is disposed at the limiting position, and is freed by the respective one of the stoppers to move from the locked position to the unlocked position when the linking lever is disposed at the releasing position.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional data storing device;

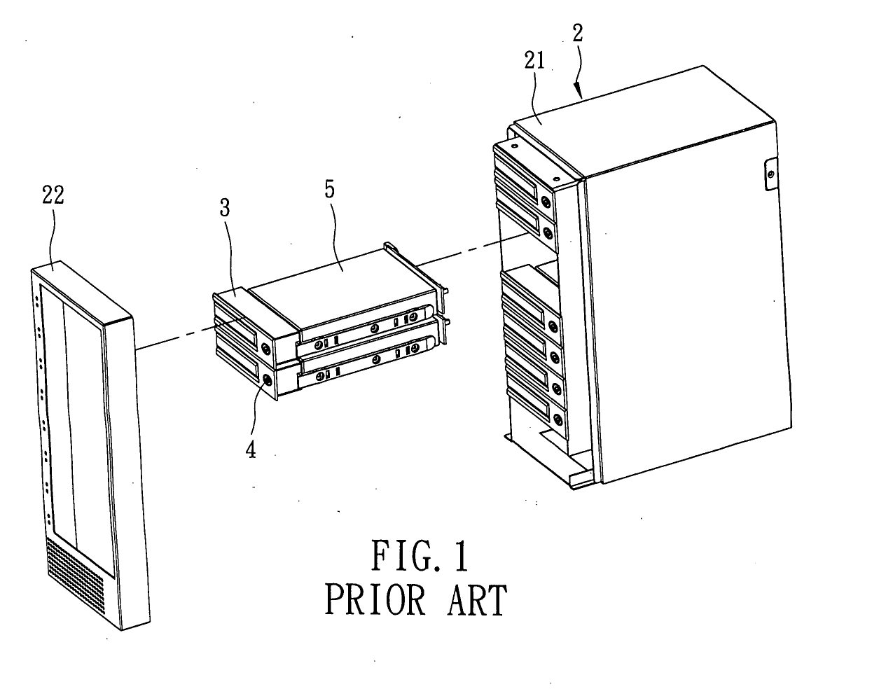

FIG. 2 is an exploded perspective view of the first preferred embodiment of a data storing device according to the present invention;

FIG. 3 is another exploded perspective view of the first preferred embodiment for illustrating a linking lever of the data storing device;

FIG. 4 is an assembled perspective view of the first preferred embodiment;

FIG. 5 is a fragmentary, partly sectional, schematic side view of the first preferred embodiment for illustrating a state where a latch is disposed at a locked position and where a linking lever is disposed at a limiting position;

FIG. 6 is a fragmentary sectional top view of the first preferred embodiment for illustrating the latch at the locked position and the linking lever at the limiting position;

FIG. 7 is a fragmentary, partly sectional, schematic side view of the first preferred embodiment for illustrating another state where the latch is disposed at an unlocked position and where the linking lever is disposed at a releasing position;

FIG. 8 is a fragmentary sectional top view of the first preferred embodiment for illustrating the latch at the unlocked position and the linking lever at the releasing position;

FIG. 9 is a fragmentary perspective view of the second preferred embodiment of the data storing device according to this invention;

FIG. 10 is a fragmentary, partly sectional, schematic side view of the second preferred embodiment for illustrating a state where the latch is disposed at a locked position and where a linking lever is disposed at a limiting position; and

FIG. 11 is a fragmentary, partly sectional, schematic side view of the second preferred embodiment for illustrating another state where the latch is disposed at the locked position and where the linking lever is disposed at a releasing position.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

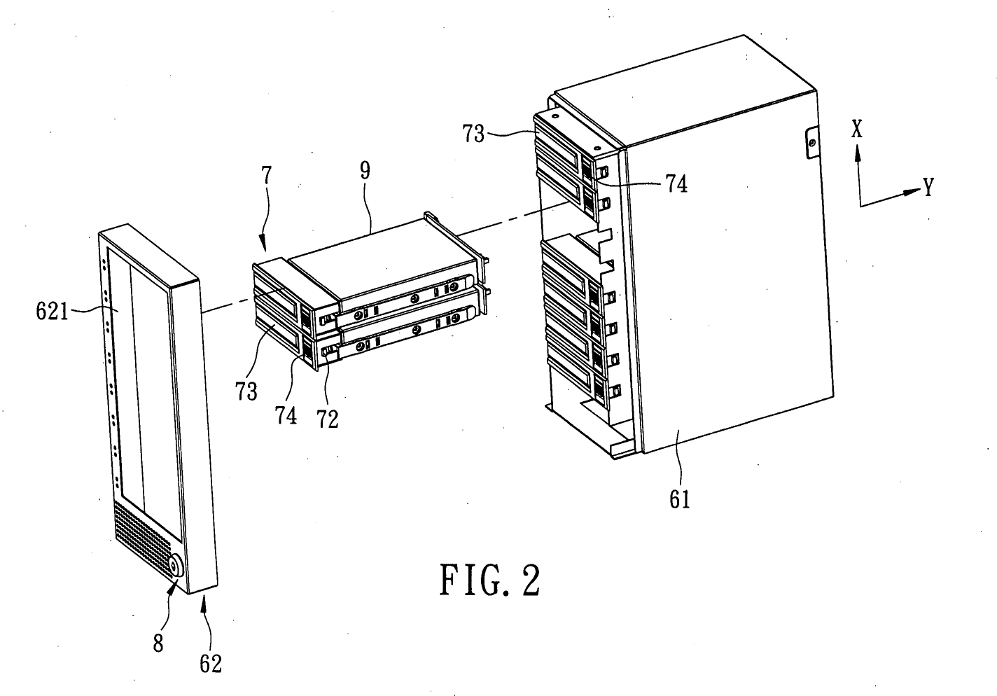

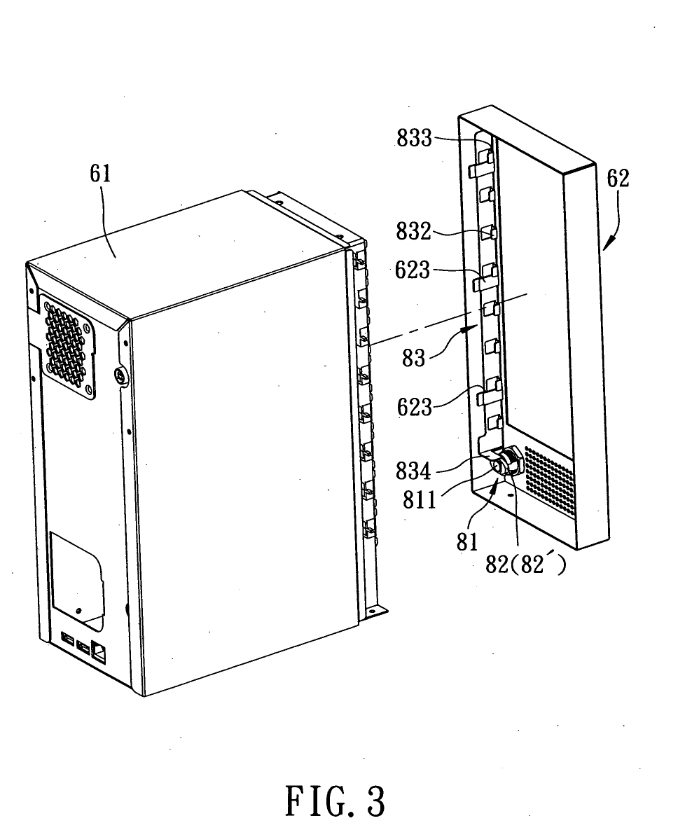

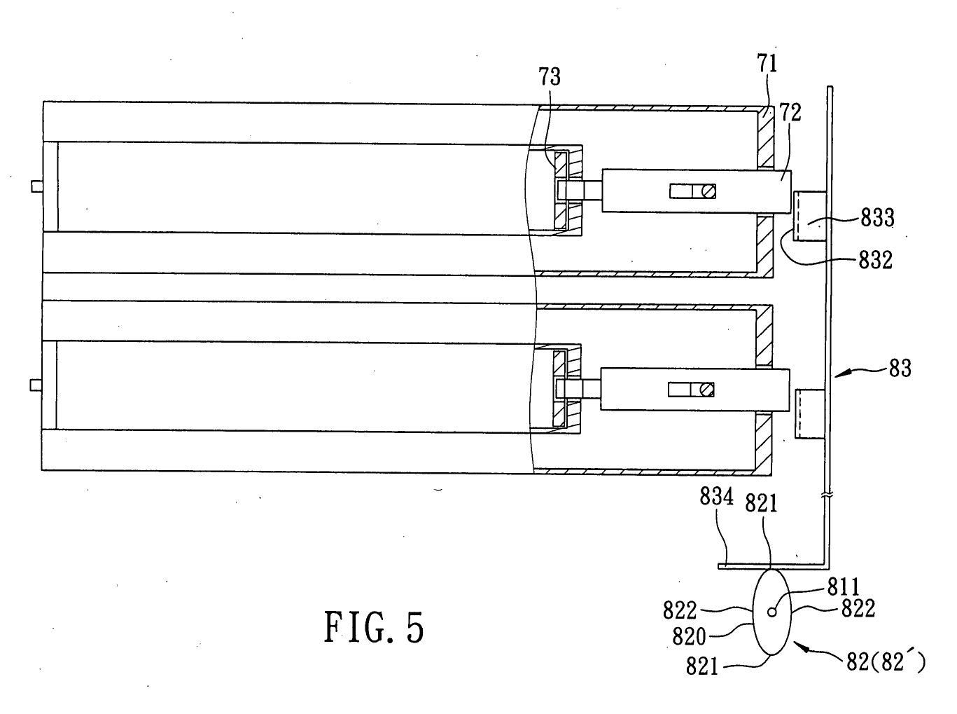

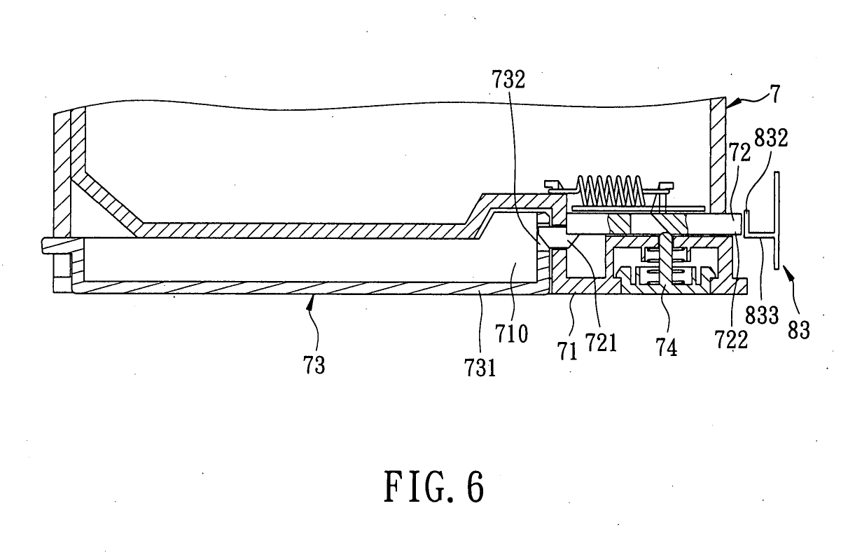

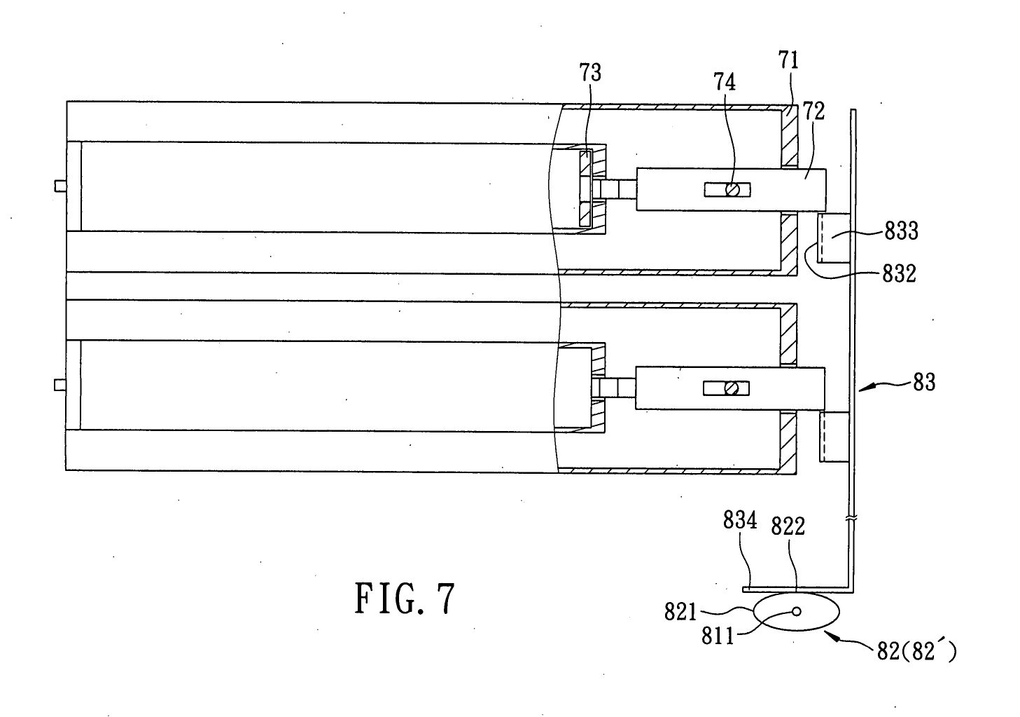

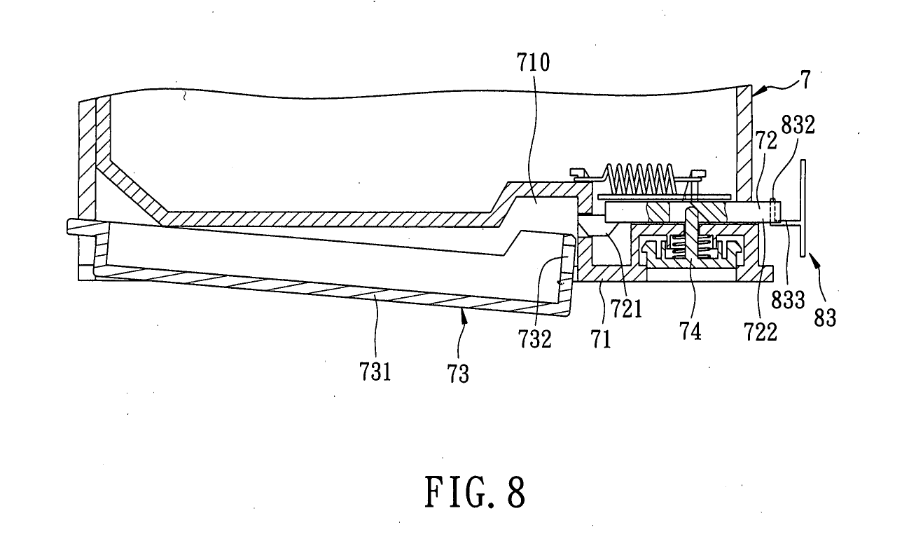

Referring to FIGS. 2 to 4, the first preferred embodiment of a data storing device according to the present invention is shown to include: a housing 61 defining an accommodating space therein and having a front cover 62 that defines a front opening 621; a plurality of carriers 7 mounted in the accommodating space in the housing 61 and aligned in a vertical direction (X), each of the carriers 7 carrying a hard disk 9 thereon, being withdrawable out of the accommodating space through the front opening 621 in the housing 61 in a horizontal direction (Y), and being provided with an operating member 73 for withdrawing the respective one of the carriers 7 out of the accommodating space, the operating member 73 of each of the carriers 7 being movable relative to the carrier 7 between a non-operable position (see FIG. 6), in which manual operation of the operating member 73 to withdraw the respective one of the carriers 7 is not permitted, and an operable position (see FIG. 8), in which manual operation of the operating member 73 to withdraw the respective one of the carriers 7 is permitted; a plurality of latches 72, each of which is mounted movably on a respective one of the carriers 7 and each of which is movable relative to the respective one of the carriers 7 between a locked position (see FIG. 5), in which the latch 72 engages the operating member 73 of a respective one of the carriers 7, thereby preventing movement of the operating member 73 of the respective one of the carriers 7 from the non-operable position to the operable position, and an unlocked position (see FIG. 7), in which the latch 72 is disengaged from the operating member 73 of the respective one of the carriers 7, thereby permitting movement of the operating member 73 of the respective one of the carriers 7 from the non-operable position to the operable position; and a limiting unit 8 mounted on the front cover 62 of the housing 61 and including a key-operated lock 81, a linking lever 83 coupled to the key-operated lock 81 and operable by the key-operated lock 81 to move relative to the housing 61 in the vertical direction (X) between limiting and releasing positions (see FIGS. 5 and 7), and a plurality of stoppers 833 provided on the linking lever 83 so as to be co-movable with the linking lever 83 in the vertical direction (X). The stoppers 833 are respectively associated with the latches 72 in such a manner that each of the latches 72 is blocked by the respective one of the stoppers 833 (see FIG. 5) from movement from the locked position to the unlocked position when the linking lever 83 is disposed at the limiting position, and is freed by the respective one of the stoppers 833 (see FIG. 7) to move from the locked position to the unlocked position when the linking lever 83 is disposed at the releasing position.

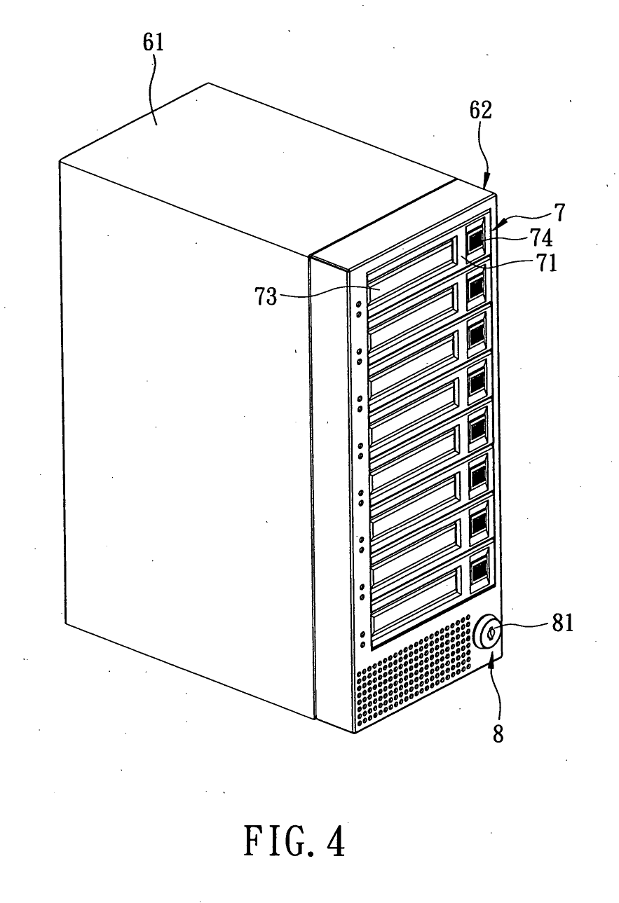

The front cover 62 has an inner side that is provided with a plurality of confining members 623 (see FIG. 4), each of which defines a slot. The linking lever 83 extends through the slots in the confining members 623 so as to be limited to move solely in the vertical direction (X). Movement of each of the latches 72 is conducted through a pressable button 74 (see FIGS. 6 and 8) which is provided on a front end 71 of each of the carriers 7. The pressable button 74 is associated with the respective one of the latches 72 in such a manner that when the pressable button 74 is pressed, the corresponding latch 72 is driven to move from the locked position to the unlocked position.

In this embodiment, the limiting unit 8 further includes a driving member 82′ (see FIG. 5) mounted rotatably on the key-operated lock 81 and operable by the key-operated lock 81 to rotate relative to the housing 61. The linking lever 83 is in sliding contact with the driving member 82′, and is driven by the driving member 82′ to move between the limiting and releasing positions.

The driving member 82′ includes an oval-shaped plate 82 that is mounted rotatably on a rotatable rod 811 of the key-operated lock 81 and that is operable to rotate relative to the housing 61 between first and second angular positions (see FIGS. 5 and 7) through operation of the key-operated lock 81 for driving movement of the linking lever 83. The oval-shaped plate 82 has a peripheral edge 820 defining a major axis with two major axial ends 821, and a minor axis with two minor axial ends 822. The linking lever 83 has a bent lower end 834 that is in sliding contact with the peripheral edge 820 of the oval-shaped plate 82 in such a manner that the lower end 834 of the linking lever 83 is seated on a selected one of the major axial ends 821 of the major axis of the oval-shaped plate 82 when the oval-shaped plate 82 is disposed at the first angular position (see FIG. 5), thereby disposing the linking lever 83 at the limiting position, and is seated on a selected one of the minor axial ends 822 of the minor axis of the oval-shaped plate 82 when the oval-shaped plate 82 is disposed at the second angular position (see FIG. 7), thereby disposing the linking lever 83 at the releasing position.

The front end 71 of each of the carriers 7 defines a front recess 710 (see FIGS. 6 and 8). The operating member 73 includes an operating lever 731 that is pivoted to the front end 71 of the respective one of the carriers 71 and that is received in the front recess 710 when the operating member 73 is disposed at the non-operable position. The operating lever 731 is formed with an engaging hole 732. Each of the latches 72 has a first end 721 which engages the engaging hole 732 in the operating lever 731 (see FIG. 6) when the latch 72 is disposed at the locked position, and which is disengaged from the engaging hole 732 in the operating lever 731 (see FIG. 8) when the latch 72 is disposed at the unlocked position. Each of the latches 72 further has a second end 722 (see FIG. 6) that is opposite to the first end 721 and that is disposed outwardly of the respective one of the carriers 7. Each of the stoppers 833 includes an L-shaped plate that extends transversely from the linking lever 83 toward the respective one of the carriers 7, and that has an end portion 832 which is aligned with the second end 722 of the respective one of the latches 72 in a transverse direction relative to the horizontal and vertical directions (Y, X) when the linking lever 83 is disposed at the limiting position (see FIGS. 5 and 6), thereby preventing movement of the corresponding latch 72 in the transverse direction from the locked position to the unlocked position, and which is misaligned with the second end 722 of the respective one of the latches 72 in the transverse direction when the linking lever 83 is disposed at the releasing position (see FIGS. 7 and 8), thereby permitting movement of the corresponding latch 72 in the transverse direction from the locked position to the unlocked position. During a carrier-withdrawing operation, the pressable button 74 of a selected one of the carriers 7 is pressed so as to move the corresponding latch 72 from the locked position to the unlocked position, thereby resulting in movement of the corresponding operating member 73 from the non-operable position to the operable position. Note that an urging member (not shown) is provided for urging the operating member 73 to move from the non-operable position to the operable position. As such, the user can hold the operating member 73 so as to pull the selected carrier 7 out of the housing 61.

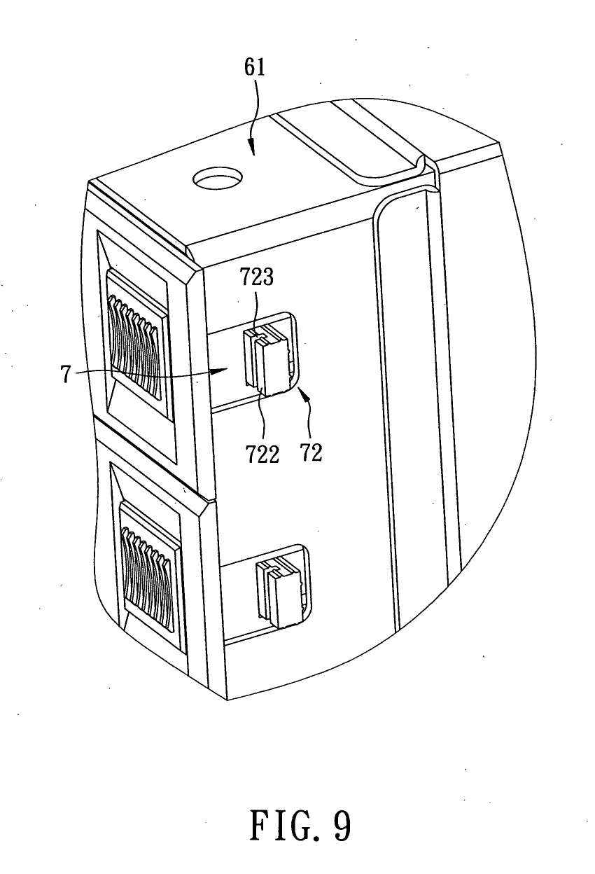

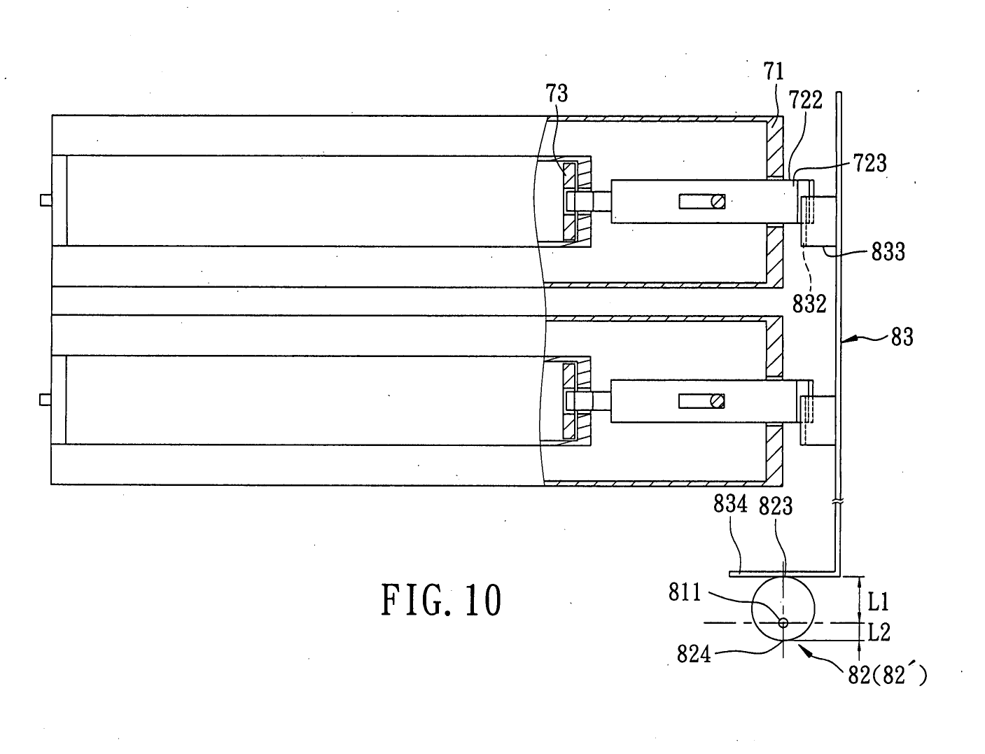

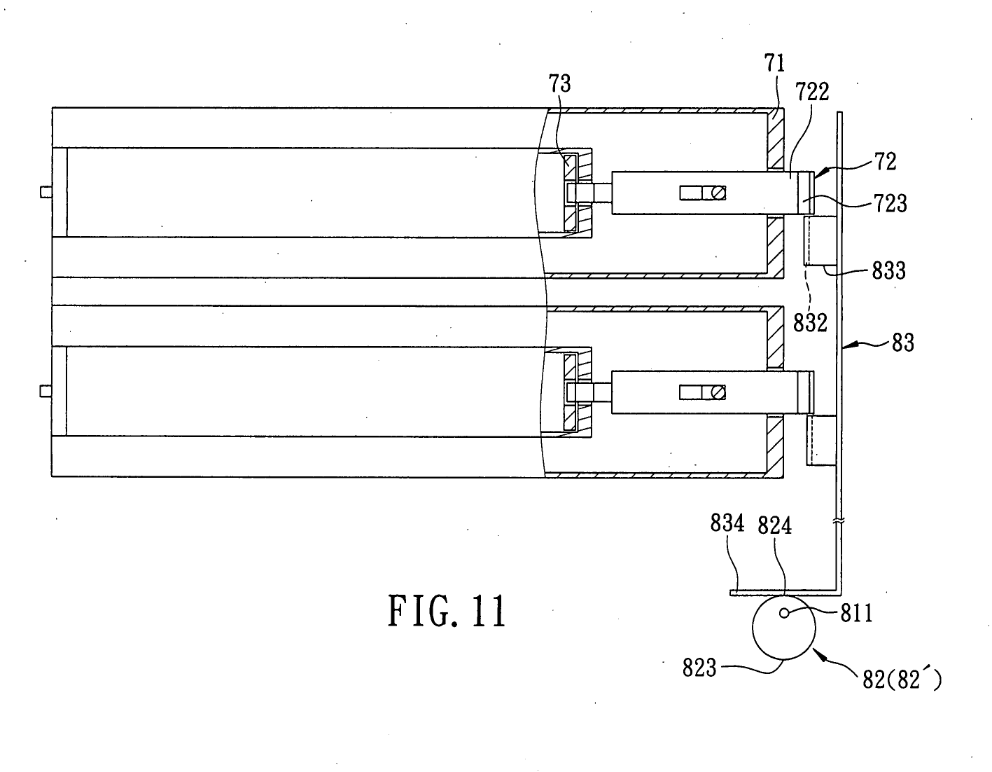

FIGS. 9 to 11 illustrate the second preferred embodiment of the data storing device according to this invention. The data storing device of this embodiment differs from the previous embodiment in that the driving member 82′ includes a circular plate 82 instead of the oval-shaped plate 82. The circular plate 82 is mounted rotatably and eccentrically on the key-operated lock 81, is rotatable about a rotation axis defined by the rotatable rod 811 of the key-operated lock 81, and has a peripheral edge 820 defining a first contact point 823 that is distanced from the rotation axis by a first distance (L1), and a second contact point 824 that is diametrically opposite to the first contact point 823 and that is distanced from the rotation axis by a second distance (L2) less than the first distance (L1). The linking lever 883 has a lower end 834 that is in sliding contact with the peripheral edge 820 of the circular plate 82 in such a manner that the lower end 834 of the linking lever 83 is seated on the first contact point 823 of the circular plate 82 when the circular plate 82 is disposed at a first angular position (see FIG. 10), thereby disposing the linking lever 83 at the limiting position, and is seated on the second contact point 824 of the circular plate 82 when the circular plate 82 is disposed at a second angular position (see FIG. 11), thereby disposing the linking lever 83 at the releasing position.

In this embodiment, each of the latches 72 has a second end 722 that is formed with an engaging groove 723 disposed outwardly of the respective one of the carriers 7. Each of the stoppers 833 includes an L-shaped plate that extends. from the linking lever 83 toward the respective one of the carriers 7, and that has an end portion 832 which extends into the engaging groove 723 in the second end 722 of the respective one of the latches 72 (see FIG. 10) when the linking lever 83 is disposed at the limiting position, and which is misaligned with the second end 722 of the respective one of the latches 72 in the transverse direction (see FIG. 11) when the linking lever 83 is disposed at the releasing position.

With the inclusion of the linking lever 83 and the stoppers 833 in the data storing device of this invention, the aforesaid drawbacks associated with the prior art can be eliminated.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A storing device comprising:
a housing defining an accommodating space therein and a front opening;
a plurality of carriers mounted in said accommodating space in said housing and aligned in a vertical direction, each of said carriers being with drawable out of said accommodating space through said front opening in said. housing in a horizontal direction, and being provided with an operating member for withdrawing the respective one of said carriers out of said accommodating space, said operating member of each of said carriers being movable relative to said carrier between a non-operable position, in which manual operation of said operating member to withdraw the respective one of said carriers is not permitted, and an operable position, in which manual operation of said operating member to withdraw the respective one of said carriers is permitted;
a plurality of latches, each of which is mounted movably on a respective one of said carriers and each of which is movable relative to the respective one of said carriers between a locked position, in which said latch engages said operating member of a respective one of said carriers, thereby preventing movement of said operating member of the respective one of said carriers from said non-operable position to said operable position, and an unlocked position, in which said latch is disengaged from said operating member of the respective one of said carriers, thereby permitting movement of said operating member of the respective one of said carriers from said non-operable position to said operable position; and
a limiting unit mounted on said housing and including a key-operated lock, a linking lever coupled to said key-operated lock and operable by said key-operated lock to move relative to said housing in said vertical direction between limiting and releasing positions, and a plurality of stoppers provided on said linking lever so as to be co-movable with said linking lever in said vertical direction, said stoppers being respectively associated with said latches in such a manner that each of said latches is blocked by the respective one of said stoppers from movement from said locked position to said unlocked position when said linking lever is disposed at said limiting position, and is freed by the respective one of said stoppers to move from said locked position to said unlocked position when said linking lever is disposed at said releasing position.

2. The storing device as claimed in claim 1, wherein said limiting unit further includes a driving member mounted rotatably on said key-operated lock and operable by said key-operated lock to rotate relative to said housing, said linking lever being in sliding contact with said driving member, and being driven by said driving member to move between said limiting and releasing positions.

3. The storing device as claimed in claim 2, wherein said driving member includes an oval-shaped plate that is mounted rotatably on said key-operated lock and that is operable to rotate relative to said housing between first and second angular positions through operation of said key-operated lock for driving movement of said linking lever.

4. The storing device as claimed in claim 3, wherein said oval-shaped plate have a peripheral edge defining a major axis with two major axial ends, and a minor axis with two minor axial ends, said linking lever having a lower end that is in sliding contact with said peripheral edge of said oval-shaped plate in such a manner that said lower end of said linking lever is seated on a selected one of said major axial ends of said major axis of said oval-shaped plate when said oval-shaped plate is disposed at said first angular position, thereby disposing said linking lever at said limiting position, and is seated on a selected one of said minor axial ends of said minor axis of said oval-shaped plate when said oval-shaped plate is disposed at said second angular position, thereby disposing said linking lever at said releasing position.

5. The storing device as claimed in claim 2, wherein said driving member includes a circular plate that is mounted rotatably and eccentrically on said key-operated lock and that is operable to rotate about an axis relative to said housing between first and second angular positions through operation of said key-operated lock for driving movement of said linking lever, said circular plate having a peripheral edge defining a first contact point that is distanced from said axis by a first distance, and a second contact point that is diametrically opposite to said first contact point and that is distanced from said axis by a second distance less than said first distance, said linking lever having a lower end that is in sliding contact with said peripheral edge of said circular plate in such a manner that said lower end of said linking lever is seated on said first contact point of said circular plate when said circular plate is disposed at said first angular position, thereby disposing said linking lever at said limiting position, and is seated on said second contact point of said circular plate when said circular plate is disposed at said second angular position, thereby disposing said linking lever at said releasing position.

6. The storing device as claimed in claim 1, wherein each of said carriers has a front end defining a front recess, said operating member including an operating lever that is pivoted to said front end of the respective one of said carriers and that is received in said front recess when said operating member is disposed at said non-operable position.

7. The storing device as claimed in claim 6, wherein said operating lever is formed with an engaging hole, each of said latches having a first end which engages said engaging hole in said operating lever when said latch is disposed at said locked position, and which is disengaged from said engaging hole in said operating lever when said latch is disposed at said unlocked position.

8. The storing device as claimed in claim 7, wherein each of said latches further has a second end that is opposite to said first end and that is disposed outwardly of the respective one of said carriers, each of said stoppers including an L-shaped plate that extends transversely from said linking lever toward the respective one of said carriers, and that has an end portion which is aligned with said second end of the respective one of said latches in a transverse direction relative to said horizontal and vertical directions when said linking lever is disposed at said limiting position, and which is misaligned with said second end of the respective one of said latches in said transverse direction when said linking lever is disposed at said releasing position.

9. The storing device as claimed in claim 7, wherein each of said latches further has a second end that is opposite to said first end of the respective one of said latches and that is formed with an engaging groove disposed outwardly of the respective one of said carriers, each of said stoppers including an L-shaped plate that extends from said linking lever toward the respective one of said carriers, and that has an end portion which extends into said engaging groove in said second end of the respective one of said latches when said linking lever is disposed at said limiting position, and which is misaligned with said second end of the respective one of said latches in a transverse direction relative to said horizontal and vertical directions when said linking lever is disposed at said releasing position.
